(19) United States
(12) Patent Application Publication
(10) Pub. No.: US 2017/0208493 A1
(43) Pub. Date: Jul. 20, 2017

(54) MANAGEMENT OF A DISTRIBUTED SENSOR SYSTEM

(71) Applicant: Qsense Inc., Boulder, CO (US)

(72) Inventors: Nicholas Bantle Masson, Boulder, CO (US); Matthew Stein, Lafayette, CA (US)

(73) Assignee: Qsense Inc., Boulder, CO (US)

(21) Appl. No.: 15/000,207

(22) Filed: Jan. 19, 2016

(51) Int. Cl. H04W 24/10; H04B 17/309; H04W 4/02; H04W 4/00

(52) U.S. Cl. CPC H04W 24/10; H04W 4/005; H04B 17/309; H04W 4/021

(57) ABSTRACT

Methods, systems, and devices are described for managing a distributed sensor system. More specifically, the described features generally relate to managing such a system to maintain or improve quality of data obtained from the system. Such management may involve receiving sensed data from sensors of the system and determining an aggregated data quality of the system based on knowledge of the quality of data from individual sensors of the system and knowledge of the geographical locations of the individual sensors. In general, the management may be performed to improve the aggregated data quality of the system. For example, a sensor of the system may be identified to be calibrated. The system may be managed to facilitate calibration of the identified sensor by identifying one or more other sensors of the system to be relocated so that the identified sensor may be calibrated using information from the other sensor(s).

### BACKGROUND

Field of the Disclosure

The present disclosure, for example, relates to managing a distributed sensor system, and more particularly to managing such a system to maintain or improve quality of data obtained from the system.

Description of Related Art

Distributed sensor systems may be deployed to collect data over an area or areas of interest. For example, environmental data (e.g., data including measurements of environmental conditions) may be collected using a plurality of sensor assemblies in different physical locations of such area(s) of interest. Such systems may employ sensors having various levels of quality, and in some examples may include relatively low cost sensors that provide lower quality data than scientific-grade instruments. Further, the sensors of such systems may be subject to outdoor conditions, and may suffer from deterioration such as sensitivity decay and/or drifting, for example.

Calibration of environmental sensors may be important to ensure that data collected is useful for a particular purpose (e.g., accurate, reliable, etc.). This is particularly true when aggregating data from a plurality of sensors as in a distributed sensor system. However, calibration may be difficult and complex, particularly when the system includes sensors of different types and/or from different manufacturers. Furthermore, employing on-site calibration, known automated calibration systems, or a reference standard for each sensor of the system may be cost prohibitive.

Thus, efficient management of a distributed sensor system to maintain or improve data quality obtained from the system (e.g., achieve a desired level of an aggregate data quality) is needed.

### SUMMARY

The described features generally relate to one or more improved systems, methods, and/or apparatuses for managing a distributed sensor system. More specifically, the described features generally relate to managing such a system to maintain or improve quality of data obtained from the system. Such management may involve receiving sensed data from sensors of the system and determining an aggregated data quality of the system based on knowledge of the quality of data from individual sensors of the system and knowledge of the geographical locations of the individual sensors (e.g., system layout). In general, the management may be performed to improve the aggregated data quality of the system. In some examples, a sensor of the system may be identified to be calibrated. The system may be managed to facilitate calibration of the identified sensor by identifying one or more other sensors of the system to be relocated (e.g., collocated with the sensor to be calibrated) so that the identified sensor may be calibrated using information from the other sensor(s).

A method for managing data quality of a distributed sensor system is described. The method may include: receiving sensed data from a plurality of sensors of the distributed sensor system at a central node of the distributed sensor system; determining, by the central node, an aggregate data quality of the distributed sensor system based at least in part on quality of data from and geographical locations of individual sensors of the plurality of sensors; and, sending a message to a user, the message requesting a relocation of at least one sensor from the plurality of sensors based at least in part on a determination by the central node that the relocation of the at least one sensor will improve the aggregate data quality of the distributed sensor system.

In some aspects, the central node may actively update the aggregate data quality based at least in part on accumulated knowledge of the quality of data from and the geographical locations of the individual sensors.

In some aspects, the central node may determine a quality metric for each of the plurality of sensors. The quality metric may be associated with quality of sensed data received from each of the plurality of sensors. In such examples, the central node may take into account the determined quality metrics for determining the aggregate data quality of the distributed sensor system.

In some aspects, the method may include determining weighting factors for individual sensors of the plurality of sensors. In such examples, the central node may take into account the determined weighting factors for determining the aggregate data quality of the distributed sensor system and determining that the relocation of the at least one sensor will improve the aggregate data quality of the distributed sensor system.

In some aspects, the central node may identify a second sensor of the plurality of sensors to be calibrated. In such examples, the central node may determine that the relocation of the at least one sensor will facilitate calibration of the second sensor. In some examples, the central node may identify the second sensor based at least in part on a calibration history of the second sensor. Alternatively or additionally, the central node may identify the second sensor based at least in part on quality of data received from the second sensor.

In some aspects, the central node may determine an incentive for performing the requested relocation of the at least one sensor. In such examples, the incentive may be determined based at least in part on a quality of the data from the at least one sensor. Alternatively or additionally, the incentive may be determined based at least in part on an expected improvement in the aggregate data quality from performing the requested relocation of the at least one sensor.

In some aspects, the central node may determine the at least one sensor to relocate based at least in part on the geographical locations of the individual sensors of the distributed sensor system. Alternatively or additionally, the central node may determine the at least one sensor to relocate based at least in part on a quality metric for each of the plurality of sensors.

An apparatus for managing data quality of a distributed sensor system is described. The apparatus may include a receiver to receive sensed data from a plurality of sensors of the distributed sensor system, a processor to determine an aggregate data quality of the distributed sensor system based at least in part on quality of data from and geographical locations of individual sensors of the plurality of sensors, and a transmitter to send a message to a user, the message requesting a relocation of at least one sensor from the plurality of sensors based at least in part on a determination by the processor that the relocation of the at least one sensor will improve the aggregate data quality of the distributed sensor system. The apparatus may include these and elements configured to perform features of the method described above and further herein.

Another apparatus for managing data quality of a distributed sensor system is described. The apparatus may include a processor and memory communicatively coupled with the processor. The memory may include computer-readable code that, when executed by the processor, causes the apparatus to: receive sensed data from a plurality of sensors of the distributed sensor system; determine an aggregate data quality of the distributed sensor system based at least in part on quality of data from and geographical locations of individual sensors of the plurality of sensors; and, send a message to a user, the message requesting a relocation of at least one sensor from the plurality of sensors based at least in part on a determination by the processor that the relocation of the at least one sensor will improve the aggregate data quality of the distributed sensor system. The memory may include computer-readable code that, when executed by the processor, causes the apparatus to perform features of the method described above and further herein.

A non-transitory computer-readable medium is described. The medium may include computer-readable code that, when executed, causes a device to: receive sensed data from a plurality of sensors of the distributed sensor system; determine an aggregate data quality of the distributed sensor system based at least in part on quality of data from and geographical locations of individual sensors of the plurality of sensors; and, send a message to a user, the message requesting a relocation of at least one sensor from the plurality of sensors based at least in part on a determination by the processor that the relocation of the at least one sensor will improve the aggregate data quality of the distributed sensor system. The medium may include computer-readable code that, when executed, causes a device to perform features of the method described above and further herein.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a distributed sensor system along with an associated central node and an associated calibration device, in accordance with various aspects of the present disclosure;

FIG. 2 shows a diagram illustrating examples of relocations of sensors of a distributed sensor system, in accordance with various aspects of the present disclosure;

FIG. 3A shows a block diagram of an example of a device configured for use in managing a distributed sensor system, in accordance with various aspects of the present disclosure;

FIG. 3B shows a block diagram of another example of a device configured for use in managing a distributed sensor system, in accordance with various aspects of the present disclosure;

FIG. 4A shows a block diagram of an example of a device configured for use in calibrating a sensor of a distributed sensor system, in accordance with various aspects of the present disclosure;

FIG. 4B shows a block diagram of another example of a device configured for use in calibrating a sensor of a distributed sensor system, in accordance with various aspects of the present disclosure;

FIG. 5 is a flow chart illustrating an example of a method for managing data quality of a distributed sensor system, in accordance with various aspects of the present disclosure;

FIG. 6 is a flow chart illustrating an example of a method for calibrating a sensor via relocation/collocation, in accordance with various aspects of the present disclosure;

FIG. 7 is a flow chart illustrating another example of a method for managing data quality of a distributed sensor system, in accordance with various aspects of the present disclosure; and

FIG. 8 is a flow chart illustrating yet another example of a method for managing data quality of a distributed sensor system, in accordance with various aspects of the present disclosure.

### DETAILED DESCRIPTION

This description discloses techniques for managing a distributed sensor system. The described management techniques may be used to maintain or improve an aggregate data quality of the system. Alternatively or additionally, the management techniques may be used to obtain a desired data quality for a particular geographical area and/or for a particular purpose. In general, a central node may manage aspects of the distributed sensor system and may, for example, receive input of one or more management parameters, such as a desired aggregate data quality, desired geographic coverage, a desired data quality for a particular area within the geographic coverage, or the like. Additionally or alternatively, such parameters may be predetermined, and stored at the central node. The central node may manage the distributed sensor system by determining relocations of sensors that will achieve the particular parameters, and/or otherwise provide directional improvements to data quality. In the context of this description, a relocation of a sensor may involve movement of a mobile sensor assembly or re-positioning of a fixed sensor assembly.

Relocation of a sensor may serve to facilitate (e.g., be employed for) calibration of another sensor via collocation, as described further herein. For example, a co-location of sensors, or a relocation of sensors within a certain proximity may be employed in a calibration routine to compensate for inaccuracies of a sensor (e.g., sensor gain and/or offset drift) and/or improve a quality metric for the sensor (e.g., uncertainty, margin of error, precision, accuracy, verified sensor range, etc.). Alternatively or additionally, relocation of a sensor may serve to improve a geographical coverage of data in the distributed sensor system (e.g., to provide a more uniform spatial distribution of sensors, to locate a sensor in a geographical area that was not represented with sufficient data, increase spatial density of sensors at an area of interest, to increase aggregate data quality at an area of interest, etc.).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

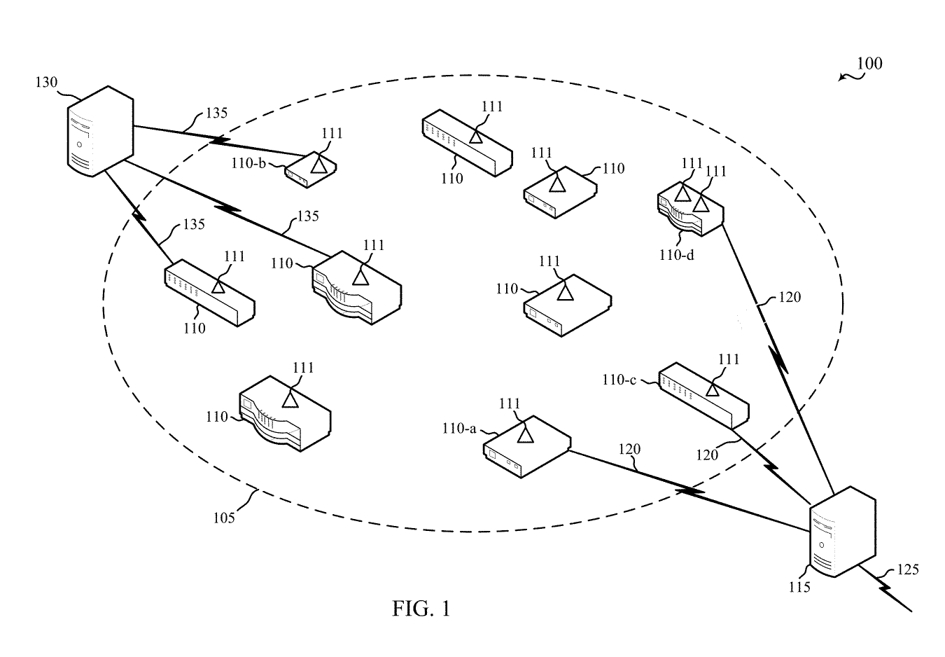

Referring first to FIG. 1, a block diagram illustrates an example of a distributed sensor system 100 in accordance with various aspects of the present disclosure. The distributed sensor system 100 may include a plurality of sensor assemblies 110 distributed over an area of interest 105, and a central node 115 or other processing device. The sensor assemblies 110 may be, for example, configured to monitor and/or assess environmental conditions that affect air quality, such as carbon monoxide, carbon dioxide, nitrogen oxides, sulfur dioxide, particulates, hydrocarbons, etc. To support such measurements, each of the sensor assemblies 110 may include one or more sensors 111, such as sensor assembly 110-a having a single sensor 111 and sensor assembly 110-d having a plurality of sensors 111. The sensors 111 may measure different environmental conditions and/or may measure some of the same environmental conditions using the same or disparate technologies. Also, the sensors 111 or the sensor assemblies 110 may each be associated with different sensing architecture, construction, age, manufacturer, and/or operational history. Thus, for various reasons, the sensors 111 of the distributed sensor system 100 may each provide sensed data that is of different quality, or is characterized by different qualities. It should be understood that the various sensors 111 or sensor assemblies 110 of the distributed sensor system 100 may be fixed in location or mobile (e.g., vehicle mounted, carried by an individual, etc.) and may be ground-based or airborne. Further, it should be understood that the distributed sensor system 100 may include sensors 111 and/or sensors assemblies 110 that are satellites or satellite-based, or may be augmented with data obtained via one or more satellites (not shown). For example, data may be derived from satellites that have the ability to measure one or more environmental conditions of discrete areas over discrete times.

Each of the sensor assemblies 110 may be associated with one or more environmental conditions that are communicated in the distributed sensor system 100. For instance, a sensor assembly 110 may transmit sensed data by way of a wired or wireless communication system. Thus, each sensor assembly 110 may include hardware and/or software to provide communication through the distributed sensor system 100. For example, each sensor assembly 110 may communicate with the central node 115 via wireless links 120 using any suitable wireless communication technology, or via a wired link (not shown). Although wireless links 120 are not shown between each of the sensor assemblies 110 and the central node 115 for the sake of simplicity, it should be understood that the central node 115 may communicate with all of the sensor assemblies 110 of the system 100, which may include wired or wireless communication links from one of the sensor assemblies 110, through another of the sensor assemblies 110, and eventually to the central node 115.

In some examples the central node 115 may receive data from one or more sensor assemblies 110 via a central data server (not shown) by way of an external communication link 125. The central data server may collect data from one or more sensors 110, and forward the data to the central node 115 continuously or in discrete packets. In such examples the data received from a sensor assembly 110 may include the location of the sensor assembly 110 as associated by the central data server, or the location of the sensor assembly 110 may be otherwise associated with the data (e.g., a lookup table, transmitted from another device such as a calibration device 130, etc.)

Data from a sensor assembly 110 may be transmitted continuously, or may be stored in a buffer at the sensor assembly before being transmitted as a data packet having data collected over a particular time period. In such an example, a data packet may be transmitted by the sensor assembly 110 upon any of a user-triggered event (e.g., a user-selected time, a data push, etc.), a sensor assembly-triggered event (e.g., a measurement exceeding a threshold, an amount of buffered data exceeding a threshold, a location of the sensor assembly being within range of a wireless network, an availability of a wired data connection at the sensor assembly, etc.) and/or a system-driven event (e.g., a predetermined daily push, an event time, an environmental condition measurement from another sensor assembly exceeding a threshold, etc.).

The central node 115 can receive sensed data from the sensor assemblies 110, and provide various functions. For instance, the central node 115 may aggregate data and perform various calculations with the received data, such as determining an aggregate data quality of the system, data quality metrics of individual sensors, etc. In some examples, the central node 115 can perform reporting or alerting functions based on the received data. In some examples, the central node 115 may include a calibration model for one or more sensors 111 that provide sensed data to the central node. In this way, calibration models may be stored at a central location, which may be in addition to, or instead of a calibration model stored locally at a sensor 111 or a sensor assembly 110. In some examples, the central node 115 can transmit any of the received data, calculations made from the received data, reports, or alerts to one or more external devices by way of an external communication link 125.

The central node 115 may determine the aggregate data quality of the system based at least in part on quality of data from and geographical locations of the individual sensors 111. In some examples, the central node 115 may mange the distributed sensor system 100 to maintain a desired aggregate data quality level (e.g., input as a management parameter). In such case, the central node 115 may determine how to improve the aggregate data quality should the determined aggregate data quality approach or fall below a threshold. In other examples, the central node 115 may mange the distributed sensor system 100 to improve the aggregate data quality level (e.g., optimize) as much as possible or practical. In such case, the central node 115 may determine how to improve the aggregate data quality on an ongoing basis (e.g., as sensors decay and/or drift over time, as environmental conditions change over time, or as management parameters are updated). Additional aspects of management of the distributed sensor system 100 by the central node 115 are discussed further herein.

Each of the sensor assemblies 110 may also measure secondary parameters that may or may not be related to the environmental conditions that are communicated through the network. In some examples, secondary parameters may support the measurement and/or calculation of environmental conditions that are communicated through the network. For example, the measurement of an atmospheric concentration of a particular gas may require secondary measurements of temperature and/or atmospheric pressure, in addition to a sensor 111. In some examples, the calibration of a sensor 111 associated with an environmental condition may be a function of a secondary parameter. For instance, a sensor gain or sensor offset for a sensor 111 that measures a concentration of an atmospheric constituent may be based on temperature. In such examples, a sensor assembly 110 that reports the concentration of the atmospheric constituent to the network may also measure temperature in order to validate, or otherwise determine a quality of the reported data.

In some examples, a sensor assembly 110 may measure secondary parameters that are not directly related to the measurement or calculation of an environmental condition, but are otherwise related to supporting the functionality of the sensor assembly 110. For instance, secondary parameters measured by the sensor assembly 110 may further include a sensor assembly power level, a sensor assembly battery charge level, a communication throughput, a network status parameter, clock time, sensor run time, or any other secondary parameter related to supporting the operation of the sensor assembly 110.

A calibration device 130 is also illustrated in FIG. 1. The calibration device 130 may, in some examples, be part of the distributed sensor system 100. As shown, the calibration device 130 may communicate with the sensor assemblies 110 via wireless communication links 135 using any suitable wireless communication technology, or via a wired link (not shown). Although wireless communication links 135 are not shown between each of the sensor assemblies 110 and the calibration device 130 for the sake of simplicity, it should be understood that the calibration device 130 may communicate with all of the sensor assemblies 110 of the system 100, which may include wired or wireless communication links from one of the sensor assemblies 110, through another of the sensor assemblies 110, and eventually to the calibration device 130. Furthermore, although the calibration device 130 and the central node 115 are shown as separate devices, in various examples the two devices, or any of the described functionality of the two devices, may be embodied in the same device.

The calibration device 130 may receive sensed data from sensors 111 as transmitted by the sensor assemblies 110, as well as an identity of each sensor 111 and/or sensor assembly 110 that is associated with the respective sensed data. In some examples the calibration device 130 may determine a location of a sensor 111 by looking up a predetermined location stored in memory associated with the calibration device 130. In some examples the calibration device 130 may receive information associated with the location of a sensor 111, which may be received from a central database, such as a database stored at the central node 115, or received from the sensor assembly 110 that includes the sensor 111. In examples where the sensor assembly 110 transmits location information for a sensor 111, the location information may be predetermined information stored at the sensor assembly 110, or may be otherwise measured by the sensor assembly 110. For instance, in some examples the sensor assembly 110 may be configured to determine its own location by receiving signals from a GPS or GLONASS satellite constellation, or any terrestrial or satellite-based system that provides positioning signals. In some examples, the location of the sensor 111 as determined by the sensor assembly 110 can be transmitted to the calibration device 130.

As discussed in further detail below, the calibration device 130 may determine a calibration model for one or more of the sensors 111. In some examples the calibration device 130 may transmit an instruction to adjust a parameter associated with the calibration of a sensor 111. For instance, the calibration device 130 may communicate calibration information (e.g., adjustments, offsets, corrections, etc.) to the respective sensor assemblies 110 to improve the correlation of the sensed data of the sensors 111, where the calibration adjustments may take place at one or both of the sensor itself, or at another portion of the sensor assembly 110 that is associated with converting an output or a sensor 111 to data representing an environmental condition. In some examples, calibration information for a plurality of sensors 111 may be communicated to a central data server (not shown), which may apply the calibration information to data received from the plurality of sensors 111 before forwarding data from the plurality of sensors 111 to the central node 115. In some examples, calibration information for a plurality of sensors 111 may be communicated to the central node 115, and the central node 115 can use calibration information to adjust sensed data from the plurality to improve correlation between sensors 111 that measure the same environmental condition.

The calibration device 130 may be configured to determine a difference in geospatial location between sensors 111 and then determine a calibration model to use for calibration of the sensors 111. For example, the calibration device 130 may determine that one of the sensor assemblies 110-a is at a relatively far distance (e.g., 1 kilometer) or proximity to another of the sensor assemblies 110-b. The relatively far distance/proximity may allow a calibration model to be used that correlates portions the sensed data from a sensor 111 of the sensor assembly 110-a reflecting a relatively steady state, or having relatively low frequency changes with corresponding sensed data from a sensor 111 of the sensor assembly 110-b. Alternatively, the calibration device 130 may determine that a different sensor assembly 110-c is at a relatively close distance (e.g., 1 meter) or proximity to the sensor assemblies 110-a. The relatively close distance/proximity may allow a calibration model to be used that correlates the sensed data from a sensor 111 of the sensor assembly 110-a including both steady state conditions and some amount of transient behavior, or otherwise relatively higher frequency changes with corresponding sensed data from a sensor 111 of the sensor assembly 110-c. Additionally, only a portion of sensed data may be selected for use in calibration. For example, omitting sensed data that is identified as being collected inside a substantially closed or maintained environment (e.g., inside a building) as opposed to being collected outside. Such identification may be made based on the sensed data and/or other information, such as a carbon dioxide level exceeding a threshold, significant reduction in GPS signal strength, or the like may indicate that the sensor 111/sensor assembly 110 is inside.

In some examples, the sensors 111 may be cross-calibrated (e.g., calibrating a sensor 111 of the sensor assembly 110-a using the sensed data from a sensor 111 of the sensor assembly 110-b, and calibrating the sensor assembly 110-b using the sensed data of the sensor assembly 110-a). However, a directionality of the calibration may be determined by the calibration device 130, for example, based at least in part on a difference in a quality of the sensed data of the sensors 111, where the quality of the sensed data may have a clear direction indicating a relationship from higher to lower quality, or the quality of the sensed data may reflect a particular characteristic of the sensed data.

In some examples, a first sensor 111 may be known by a calibration device 130 to be a scientific-grade instrument that has well-known and/or precisely calibrated sensor characteristics such as gain or offset. A second sensor 111 may be known by the calibration device 130 to be a lower-grade instrument having poorer performance characteristics (e.g., invariant characteristics limited by hardware and/or physics) such as greater uncertainty with respect to the sensor characteristics such as gain or offset. In other examples the grades of the first sensor 111 and the second sensor 111 may be otherwise provided to the calibration device 130, such as a transmission from a sensor assembly 110 having the sensor 111. In such examples the calibration device 130 may determine that the sensed data from the first sensor 111 has a higher quality than sensed data from the second sensor 111, based on the grades of the sensors 111 and/or the sensor assemblies 110 that include each sensor 111.

In some examples, a difference in quality may be related to an age of a sensor 111 or an age of a sensor assembly 110 that includes a sensor 111. For example, a first sensor 111 may be older than a second sensor 111, and the first sensor 111 may have a known or unknown level of drift, reduced sensitivity, and/or fouling. In such examples a calibration device 130 may determine that sensed data from the second sensor 111 has a higher quality than sensed data from the first sensor 111, based on the known ages of the sensors 111.

In some examples, a difference in quality may be related to a characteristic of the sensed data from the first and second sensors 111. For example, the first and second sensors 111 may be identically constructed, and or be part of identically constructed sensor assemblies 110, but sensed data from the first sensor 111 may have greater signal noise than sensed data from the second sensor 111. In such examples a calibration device 130 may determine that sensed data from the second sensor 111 has a higher quality than sensed data from the first sensor 111, based on the known level of noise in the sensed data from each of the sensors 111.

In some examples, a difference in quality may be related to an amount of data. For example, a first sensor 111 and a second sensor 111 may be identically constructed, but the first sensor 111 may have been deployed earlier than the second sensor 111, and sensed data from the first sensor 111 may have a greater validation history than sensed data from the second sensor 111. In such examples a calibration device 130 may determine that sensed data from the first sensor 111 has a higher quality than sensed data from the second sensor 111, based on the known amount of sensed data from each of the sensors 111.

In some examples, a difference in quality may be related to a periodicity of data. For example, first and second sensors 111 may be configured to measure data at different rates, or during different time periods. In examples where sampling rates are different, it may be suitable to use data from a sensor 111 having a higher sampling rate to contribute to the calibration of a sensor 111 having a lower sampling rate, but not vice-versa. In some examples where a first sensor 111 measures an environmental condition continuously and a second sensor 111 measures the environmental condition intermittently, or experiences data drop-outs, it may be suitable to use data from the first sensor 111 to contribute to the calibration of the second sensor 111, but not vice versa. Thus, in either case, the calibration device 130 can ascribe a quality to each of the sensors 111, and determine a difference in the quality of sensed data based on the periodicity of the sensed data

The directionality of the calibration may be from a sensor 111 associated with higher quality sensed data to a sensor 111 associated with lower quality sensed data, for example. However, even though one sensor 111 may have higher quality components or construction than another sensor 111, the sensor having higher quality components or construction may be calibrated using the sensed data of a sensor having lower quality components or construction when the lower quality sensor provides sensed data having higher quality, or a particular quality. In other examples, the directionality of calibration may include a direction from a sensor 111 associated with lower quality sensed data to a sensor 111 associated with higher quality sensed data, but the calibration effect or magnitude may be reduced as compared to a higher-to-lower quality directionality.

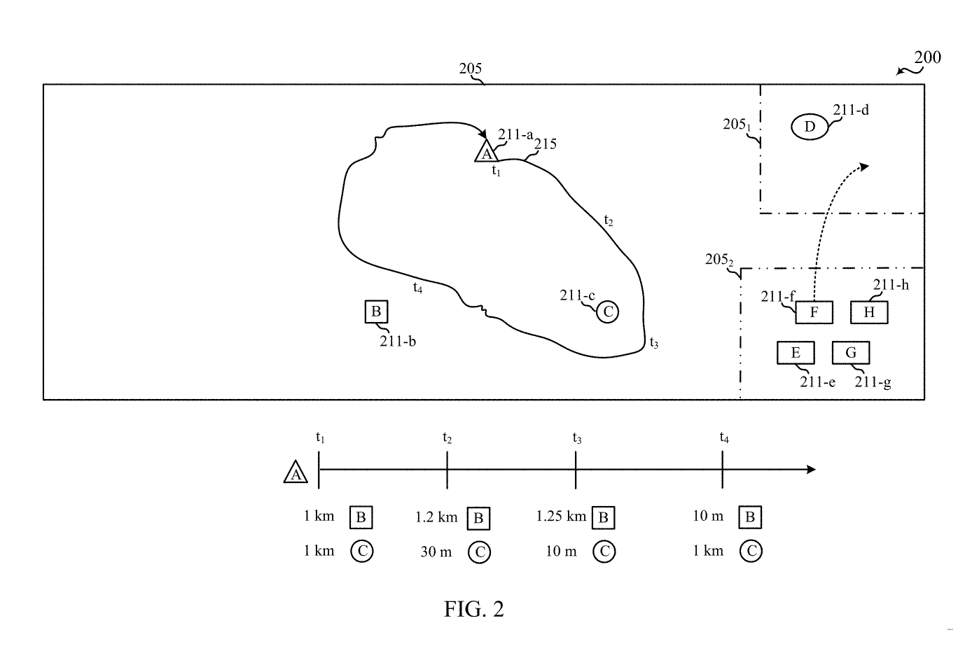

FIG. 2 shows a diagram 200 illustrating examples of relocations of sensors of a distributed sensor system, in accordance with various aspects of the present disclosure. The diagram 200 depicts sensors 211 (denoted A-H) of a distributed sensor system, distributed within an area of interest 205. In this example, the sensor A is a mobile sensor 211-a that traverses a path 215 over time, while the sensors B-H are fixed-position sensors 211-b through 211-h. The diagram 200 further depicts a timeline for the travel of the sensor 211-a showing relative distances from the sensors 211-b and 211-c.

As shown, sensor 211-a may begin at an initial location that is approximately 1 kilometer (km) from each of sensors 211-b and 211-c at time t₁. In this example, the 1 km difference in location between the location of sensor 211-a and the locations of sensors 211-b and 211-c may not allow either of sensors 211-b or 211-c to be calibrated using the sensed data of sensor 211-a (e.g., sensor 211-a not being sufficiently close (collocated) to sensor 211-b or sensor 211-c for a given calibration model).

As the sensor 211-a traverses the path 215, the sensor 211-a moves closer to the sensor 211-c, but remains relatively far from the sensor 211-b, such as at times t₂ and t₃. In this example, the 1.2 km/1.25 km differences between the location of sensor 211-a and the location of sensor 211-b may still not allow sensor 211-b to be calibrated using the sensed data of sensor 211-a. However, the 30 meter (m)/10 m differences between the location of sensor 211-a and the location of sensor 211-c may permit calibration of sensor 211-c using the sensed data of sensor 211-a, or vice versa. The sensed data used for calibration at this point may include data that is sensed around the time t₂ as well as data that is sensed around the time t₃ (e.g., under circumstances where the calibration model has not changed). In some cases, however, the sensed data used for calibration at this point may be limited to data that is sensed around the time t₃, for example, because of differences between the surroundings (e.g., topography) of sensor 211-a at times t₂ and t₃.

At time t₄, sensor 211-a moves closer to sensor 211-b, but moves further away from sensor 211-c. In this example, the 10 m difference in location between the location of sensor 211-a and the location of sensor 211-b may be small enough to use the sensed data of sensor 211-a for calibrating sensor 211-b, or vice versa. The sensed data used for such calibration at this point may be limited to data that is sensed around the time t₄ (e.g., while the difference in location (A-B) and the surroundings of sensor 211-a remain about the same).

It should be understood that the number of sensors 211, whether fixed-position or mobile, may vary and that the sensor arrangement depicted in FIG. 2 is only an example. Further, it should be understood that the path 215 as well as the differences in locations set forth (1 km, 1.2 km, 1.25 km, 30 m and 10 m) are only for purpose of illustration, and that differences in geospatial locations between sensors 211 may vary in practice and values of such differences for determining which calibration model to use may be determined for a particular implementation and/or may vary (e.g., based at least in part on topography). In some examples, additional criteria may be used to determine whether or not any calibration is to be performed. For example, the difference in geospatial locations between sensors 211 may indicate that calibration (e.g., using one or more calibration models) is possible, but other factors such as existing topography and/or prevailing wind speed may indicate that cross-calibration between the two sensors is inappropriate or limited (e.g., to a certain degree).

The diagram 200 also depicts a first sub-area of interest 205₁ in which sensor 211-d is located and a second sub-area of interest 205₂ in which sensors 211-e, 211-f, 211-g and 211-h are located. In this example, first sub-area of interest 205₁ may be of less importance than second sub-area of interest 205₂. However, it may be determined that an additional sensor located in the first sub-area of interest 205₁ may improve the quality of data for the first sub-area of interest 205₁ and/or the aggregate data quality of the area of interest 205 (e.g., by collocating another sensor with sensor 211-d for calibration and/or locating a higher-quality sensor in the first sub-area of interest 205₁). Alternatively or additionally, it may be determined that sensor 211-d does not provide enough data for the first sub-area of interest 205₁. It may also be determined that sufficient data and/or sufficient data quality is obtained by having only sensors 211-e, 211-g and 211-h located in the second sub-area of interest 205₂. In such case, relocating sensor 211-f to the first sub-area of interest 205₁ may serve to improve the amount and/or quality of data for the first sub-area of interest 205₁ and/or improve the aggregate data quality of the system, while still obtaining sufficient data and/or data quality for the second sub-area of interest.

The various examples of sensor relocations illustrated in FIG. 2 may be implemented as part of a management strategy for the distributed sensor system. It should be understood, however, that such examples are not exhaustive. Further, it should be understood that addition and/or removal of sensors may be implemented to manage the distributed sensor system. For example, rather than relocating sensor 211-f to the first sub-area of interest 205₁, a sensor (not shown) may be added to the system and located in the first sub-area of interest 205₁. Further, removal of sensor 211-f from the second sub-area of interest 205₂ may remove the sensor 211-f from the system, for example, should sensor 211-f fail or otherwise become unreliable for data.

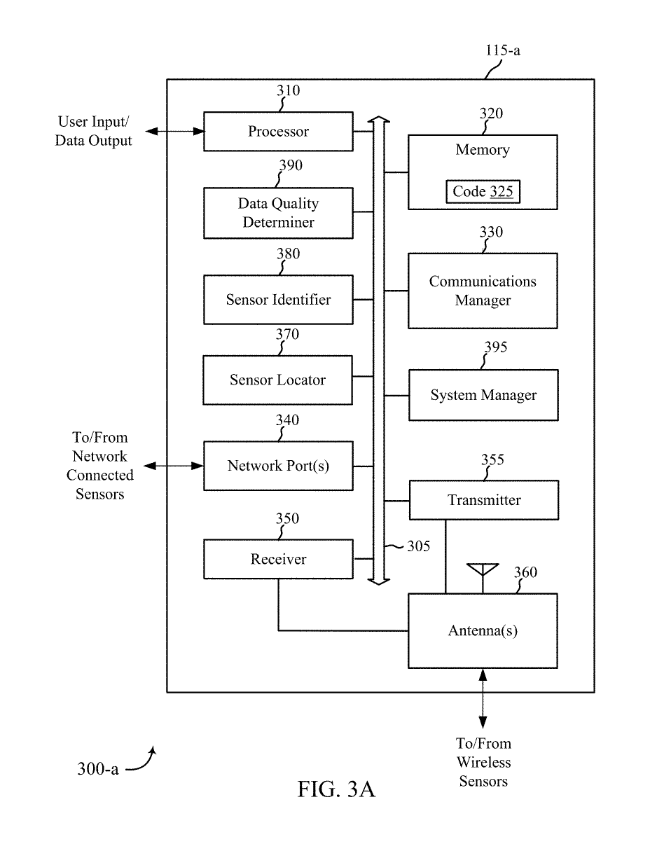

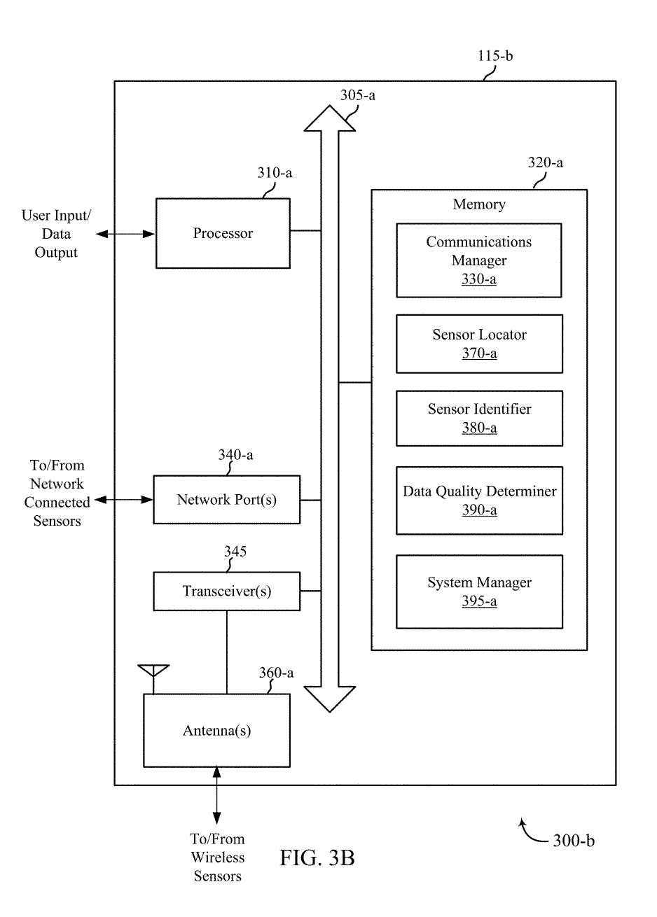

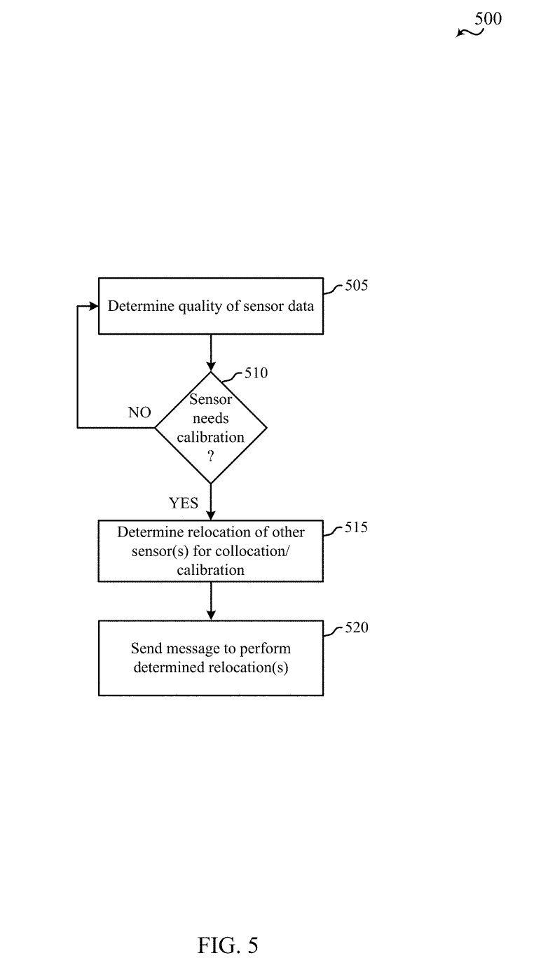

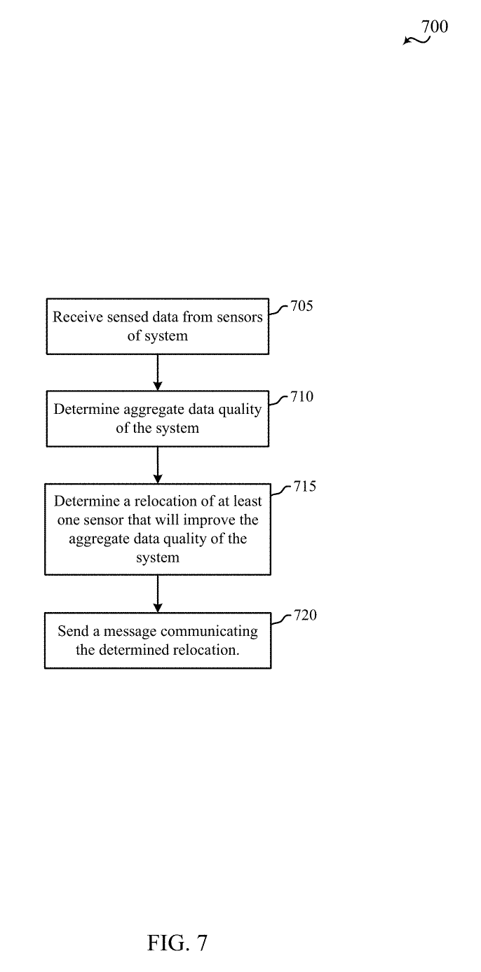

Turning to FIG. 3A, block diagram 300-a is shown that illustrates a central node 115-a for use in managing sensors 111 of a distributed sensor system 100, in accordance with various aspects of the present disclosure. The central node 115-a may have various other configurations and may be included or be part of a personal computer (e.g., laptop computer, netbook computer, tablet computer, etc.), a cellular telephone, a PDA, an internet appliance, a server, etc. The central node 115-a can have an internal power supply (not shown), such as a battery or a solar panel, to facilitate mobile operation, or may be powered via a another source such as a conventional electrical outlet (not shown) when employed in a more stationary fashion (e.g., in an office building). The central node 115-a is an example of the central node 115 of FIG. 1 and may perform aspects of managing data quality in a distributed sensor system (e.g., number and/or locations of sensors, calibration and/or verification of individual sensors, etc.) such as described herein with respect to FIGS. 1 and 2 or in accordance with aspects of the methods described with respect to FIGS. 5, 7 and/or 8.

As shown, the central node 115-a may include a processor 310, a memory 320, a receiver 350, a transmitter 355, one or more network ports 340, one or more antennas 360, and a communications manager 330. Each of these components may be in communication with each other, directly or indirectly, over at least one bus 305.

The memory 320 can include RAM and ROM. The memory 320 may store computer-readable, computer-executable software or firmware code 325 containing instructions that are configured to, when executed, cause the processor 310 to perform various functions described herein for managing a distributed sensor system 100. Alternatively, the code 325 is not directly executable by the processor 310 but is configured to cause a computer (e.g., when compiled and executed) to perform functions described herein.

The processor 310 can include an intelligent hardware device, e.g., a computer processing unit (CPU), a microcontroller, an application-specific integrated circuit (ASIC), a field-programmable gate array (FPGA), etc. The processor 310 may processes information received through the receiver 350 and/or to be sent to the transmitter 355 for transmission through the antenna(s) 360. Alternatively or additionally, the processor 310 may processes information received through the network port(s) 340 and/or to be sent via the network port(s) 340 to network connected sensors. The processor 310 may handle, alone or in connection with the communications manager 330, aspects for communicating with various devices of the distributed sensor system 100, including any one or more of sensor assemblies 110, a calibration device 130, or a central server.

The central node 115-a also may receive and process (via the processor 310) input from a user (e.g., an administrator, or the like) via an input device (not shown), such as parameters for managing the aspects of the distributed sensor system. Any suitable input device (e.g., keyboard, mouse, touchscreen, microphone, etc.) may be employed. The central node 115-a also may output various data via an output device, such as sensed data received from the sensors of the distributed sensor system, data calculated from the sensed data (e.g., aggregated data), as well as data regarding the system and/or individual sensors (e.g., aggregate data quality, individual sensor data quality and/or metrics, system configuration (e.g., number of sensors, types of sensors, layout/locations of sensors, etc.), status of sensors, movements of mobile sensors, completed and/or requested relocations of sensors, associated incentives, etc.).

The network port(s) 340 and the receiver 350 and transmitter 355 may be configured to communicate bi-directionally with the sensor assemblies 110 of the distributed sensor system, such as described with respect to FIG. 1. The receiver 350 and transmitter 355 can be implemented as a transceiver. While the central node 115-a can include a single antenna, there are aspects in which the central node 115-a includes multiple antennas 360.

The communications manager 330 manages communications with the sensor assemblies 110 of the distributed sensor system 100, for example, including sensor identities, geospatial locations, sensed data, calibration information (e.g., corrections, adjustments, directionality, etc.), data quality information, and management messages (e.g., requests for performance of an action). The communications manager 330 may be a component of the central node 115-a in communication with some or all of the other components of the central node 115-a over the at least one bus 305. Alternatively, functionality of the communications manager 330 can be implemented as a component of the network port(s) 340 and/or the receiver 350 and transmitter 355, as a computer program product, and/or as at least one controller element of the processor 310. In some examples the communications manager 330 may be configured to manage communications with a central server, and receive data and/or other sensor information from the central server.

According to the architecture of FIG. 3A, the central node 115-a further includes a sensor locator 370, a sensor identifier 380, a data quality determiner 390 and a system manager 395, each of which can be controlled by or operate in conjunction with the communications manager 330. The sensor locator 370 may determine locations of the various sensors 111 of the distributed sensor system 100, or may receive locations from the sensor assemblies 110 that include the sensors 111 themselves or from another source (e.g., locations provided based on a particular layout of fixed-location sensors, locations determined from GPS signals received at sensor assemblies 110, etc.). This information may be stored in memory 320 and actively updated while maintaining a history of sensor movements. The system manager 395 may use such information to determine relocations of sensors that will improve the data quality of the system (e.g., relocation of sensors to locations where data and/or increased data density is desired, changes in a difference in geospatial location between sensors 111 for performing a calibration procedure, etc.).

The sensor identifier 380 performs various operations and/or procedures for identifying the sensors 111 of the distributed sensor system 100. For example, the sensor identifier 380 may determine, in addition to identity, information regarding the sensors 111 such as sensor type (including the type of data sensed, how such data is sensed (e.g., sensor technology employed), and/or sensor specifications (calibration frequency, drift and/or decay metrics, sensor quality, etc.), sensor age and/or operational history, and the like. This information also may be stored in memory 320 and actively updated (e.g., over time). The system manager 395 also may use such information to determine relocations of sensors that will improve the aggregate data quality of the system.

The data quality determiner 390 may operate in conjunction with the processor 310, employing the information from the sensor locator 370 and the sensor identifier 380 to determine an aggregate data quality for the distributed sensor system 100. The data quality determiner 390 also may determine quality of sensed data from individual sensors 111 (e.g., determine data quality metrics for the individual sensors). The determined aggregate data quality and the data quality metrics may be stored in memory 320 for use by the system manager 395.

The data quality determiner 390 may determine data quality metrics for the individual sensors using a variety of factors and information. For example, prior knowledge (e.g., not based on observations or changes over time) such as sensor hardware specifications, calibration requirements (e.g., calibration frequency), drift and/or decay metrics, and the like may be used. Additionally, a calibration history of the individual sensor may be used to determine the quality metric for that sensor.

The system manager 395 may manage the distributed sensor system 100 as described herein. The system manager 395 may control or otherwise cooperate with the data quality determiner 390 to determine modifications of the system 100 that will maintain or improve aggregate data quality of the system 100, maintain or improve data quality of individual sensors or sub-groups of sensors, obtain sufficient data and/or data quality for a sub-region of interest and/or a particular purpose, etc., depending on the management parameters employed (e.g., input by a user/administrator as described above).

The system manager 395 may determine weighting factors for individual sensors, for example, based at least in part on the quality of the individual sensor and/or the quality of the sensed data from the individual sensor, based at least in part on the management parameters, etc. Alternatively, the weighting factors may be input by a user/administrator. The weighting factors may be taken into account when determining the aggregate data quality of the system 100. The weighting factors may also be taken into account when determining modifications of the system 100. For example, the weighting factors may be set to assign priority to certain sensors or to sensors within a certain area(s), so that the system manager 395 may determine modifications to augment certain sensors (e.g., regardless of the overall network quality/data quality).

As described herein, the system manager 395 may determine modifications to the system 100, such as sensor relocations, adding sensors, removing sensors, replacing sensors, etc. In some examples, the system manager 395 may determine that the aggregate quality of data from a distributed sensor system 100 would be improved by moving a particular sensor 111 closer to, or within an area of interest. Thus, the system manager 395 may identify a sensor 111 that is providing relatively low quality data (e.g., collecting data that is relatively far from an area of interest, or collecting data in an area associated with relatively high sensor density), and identify an area where such a sensor 111 should be relocated to. Additionally or alternatively, the system manager 395 may determine that that an individual sensor 111 is in need of calibration (e.g., based on a calibration history of the sensor and/or quality of data from the sensor) and may send a message (e.g., instruction) to the calibration device to perform the calibration of the sensor. If another sensor is not sufficiently close (collocated) to the sensor to be calibrated by the calibration device 130, the system manager 395 may determine a relocation of at least one other sensor of the system to facilitate calibration, and may send a message to the sensor 111 or an operator of the sensor 111 to perform a sensor relocation. The system manager 395 may determine the sensor(s) to relocate based on efficiency of movement/relocation, movement trends of mobile sensors, relative quality of the sensors and/or area coverage, etc.

The system manager 395 may be configured to take into account knowledge gained over time regarding the distributed sensor system 100, the individual sensors 111, and the results of requested modifications. For example, the system manager 395 may implement various learning algorithms (e.g., Bayesian learning, belief systems, etc.), whether known or hereafter developed, and apply such learning to variables, such as closest distance, greatest delta in quality between sensors, probabilistic assessment of requested actions being performed, etc.

The system manager 395 may implement determined relocations (or other modifications) by sending messages to a third party agent (e.g., a person or device in control of the individual sensor(s), such as a user of a mobile sensor, a vehicle carrying the mobile sensor, etc.) to take action. The system manager 395 may communicate such messages, for example, using the transmitter 355 and the antenna(s) 360. If the desired action is not performed (e.g., within a certain time period) the system manager 395 may select an alternative sensor for the relocation, and send a corresponding message to the associated third party agent. Alternatively, the system manager 395 may reevaluate and determine a new relocation based on updated information.

The system manager 395 also may determine an incentive for the third party agent to perform the requested relocation. The determined incentive may be communicated to the third party agent along with the message requesting action, for example. The incentive may be awarded to the third party agent or a manager of the third party agent once the action (e.g., relocation, successful calibration, etc.) has been completed and recognized by the system manager 395 (e.g., via updated sensor or system information, improved data quality associated with action, etc.).

The incentive may be monetary or non-monetary. A credit or point system may be employed, for example. Third party agents may accumulate credits/points by performing actions requested by the system manager. Additionally, third party agents may accumulate credits/points for sensed data provided to the central node 115-a. Accumulated credits/points may be exchanged for money and/or for products (e.g., sensors, sensor equipment upgrades, or unrelated items). Additionally or alternatively, accumulated credits/points over a certain time period (e.g., a week, a month and/or year) may result in recognition (e.g., announcement of a “winner” for the period, an award (e.g., plaque), or the like) for the third party agents.

The system manager 395 may determine a value for the incentive based on a value of the requested action. For example, the incentive offered for a particular relocation of a sensor may be based, at least in part, on an expected improvement in the aggregate data quality of the system (or an expected improvement in the data quality of individual sensors) from performance of the relocation. Alternatively or additionally, the incentive may be based at least in part on the quality of the sensor being relocated (or the quality of the sensed data from the sensor being relocated). The weighting factors associated with the sensors involved with the requested action also may be used to determine the incentive offered for completion of the action. In general, the system manager 395 may determine incentives in accordance with the objective of and/or the expected benefit from the requested action.

Thus, the components of the central node 115-a may be configured to implement aspects discussed above with respect to FIGS. 1 and 2. Moreover, the components of the central node 115-a may be configured to implement aspects discussed below with respect to FIGS. 5, 7 and 8, and those aspects may not be repeated here for the sake of brevity.

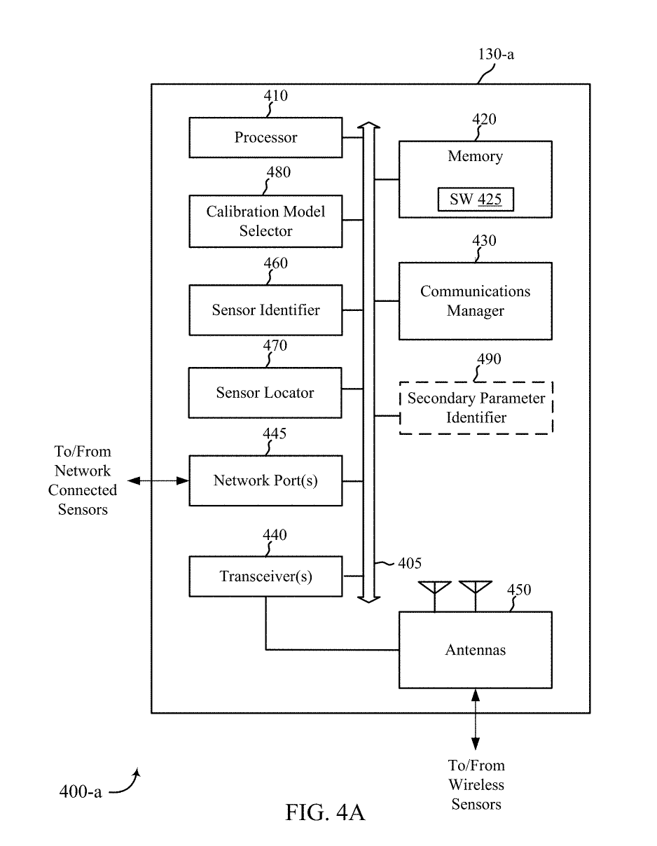

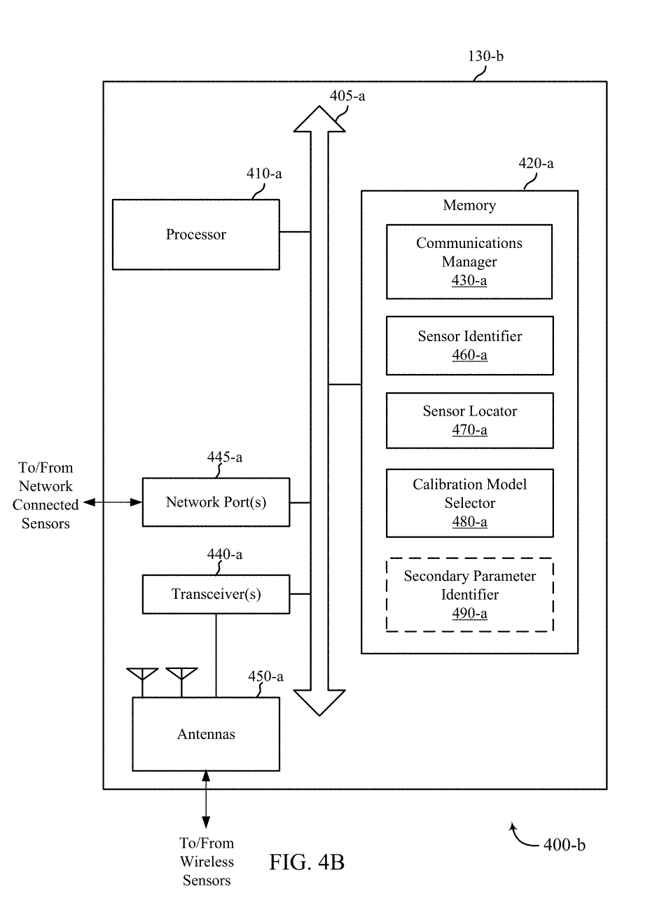

FIG. 3B shows a block diagram 300-b that illustrates a central node 115-b for use in managing a distributed sensor system 100, in accordance with various aspects of the present disclosure. The central node 115-b is another example of the central nodes 115 of FIGS. 1 and 3A, and may implement various aspects described with reference to FIGS. 2, 5, 7 and 8. As shown, the central node 115-b includes a processor 310-a, a memory 320-a, at least one transceiver 345, at least one network port 340-a and at least one antenna 360-a. Each of these components are in communication, directly or indirectly, with one another (e.g., over a bus 305-a). Each of these components may perform the functions described above with reference to FIG. 4A.

In this example, the memory 320-a includes software that performs the functionality of a communications manager 330-a, a sensor locator 370-a, a sensor identifier 380-a, a data quality determiner 390-a and a system manager 395-a. For example, memory 320-a includes software that, when compiled and executed, causes the processor 310-a (or other components of the central node 115-b) to perform the functionality described above and further below. A subset of the functionality of the communications manager 330-a, the sensor locator 370-a, the sensor identifier 380-a, the data quality determiner 390-a and the system manager 395-a can be included in memory 320-a; alternatively, all such functionality can be implemented as software executed by the processor 310-a to cause the central node 115-b to perform such functions. Other combinations of hardware/software can be used to perform the functions of the communications manager 330-a, the sensor locator 370-a, the sensor identifier 380-a, the data quality determiner 390-a and/or the system manager 395-a.

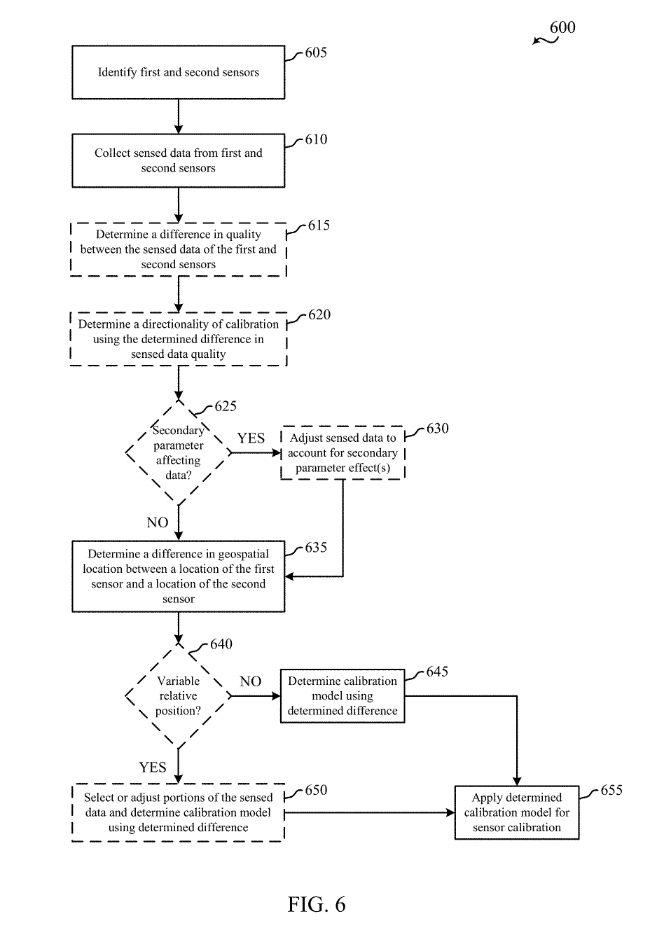

Turning to FIG. 4A, block diagram 400-a is shown that illustrates a calibration device 130-a for use in calibrating one or more sensors 111 of a distributed sensor system 100, in accordance with various aspects of the present disclosure. The calibration device 130-a may have various other configurations and may be included or be part of a personal computer (e.g., laptop computer, netbook computer, tablet computer, etc.), a cellular telephone, a PDA, an internet appliance, a server, etc. The calibration device 130-a can have an internal power supply (not shown), such as a small battery or a solar panel, to facilitate mobile operation, or may be powered via a another source such as a conventional electrical outlet (not shown) when employed in a more stationary fashion (e.g., in an office building). The calibration device 130-a is an example of the calibration device 130 of FIG. 1 and may perform calibration operations such as described herein with respect to FIGS. 1 and 2 or in accordance with aspects of the method described with respect to FIG. 6.

As shown, the calibration device 130-a may include a processor 410, a memory 420, one or more transceivers 440 and/or one or more network ports 445, antennas 450, and a communications manager 430. Each of these components may be in communication with each other, directly or indirectly, over at least one bus 405.

The memory 420 can include RAM and ROM. The memory 420 may store computer-readable, computer-executable software (SW) 425 containing instructions that are configured to, when executed, cause the processor 410 to perform various functions described herein for calibrating sensors of a distributed sensor system 100. Alternatively, the software 425 is not directly executable by the processor 410 but is configured to cause a computer (e.g., when compiled and executed) to perform functions described herein.

The processor 410 can include an intelligent hardware device, e.g., a computer processing unit (CPU), a microcontroller, an application-specific integrated circuit (ASIC), a field-programmable gate array (FPGA), etc. The processor 410 may processes information received through the transceiver(s) 440 and/or to be sent to the transceiver(s) 440 for transmission through the antennas 450. Alternatively or additionally, the processor 410 may processes information received through the network port(s) 445 and/or to be sent via the network port(s) 445 to network connected sensors. The processor 410 may handle, alone or in connection with the communications manager 430, various aspects for communicating with the sensors of the distributed sensor system.

The transceiver(s) 440 and the network port(s) may be configured to communicate bi-directionally with the sensor assemblies 110 of the distributed sensor system, such as described with respect to FIG. 1. The transceiver(s) 440 can be implemented as at least one transmitter and at least one separate receiver. While the calibration device 130-a can include a single antenna, there are aspects in which the calibration device 130-a includes multiple antennas 450.

The communications manager 430 manages communications with the sensor assemblies 110 of the distributed sensor system 100, for example, including sensor identities, geospatial locations, sensed data, and calibration information (e.g., corrections, adjustments, directionality, etc.). The communications manager 430 may be a component of the calibration device 130-a in communication with some or all of the other components of the calibration device 130-a over the at least one bus 405. Alternatively, functionality of the communications manager 430 can be implemented as a component of the transceiver(s) 440 and/or the network port(s) 445, as a computer program product, and/or as at least one controller element of the processor 410.

According to the architecture of FIG. 4A, the calibration device 130-a further includes a sensor identifier 460, a sensor locator 470, a calibration model selector 480 and a secondary parameter identifier 490, each of which can be controlled by or operate in conjunction with the communications manager 430. The sensor identifier 460 performs various operations and/or procedures for identifying the sensors 111 of the distributed sensor system 100. For example, the sensor identifier 460 may determine, in addition to identity, information regarding the sensors 111 such as sensor type (including the type of data sensed and how such data is sensed (e.g., sensor technology employed), sensor quality and/or quality of sensed data provided, etc.).

The sensor locator 470 may determine locations of the various sensors 111 of the distributed sensor system 100, or may receive locations from the sensor assemblies 110 that include the sensors 111 themselves or from another source (e.g., locations provided based on a particular layout of fixed-location sensors), and then determine a difference in geospatial location between sensors 111 involved in a calibration procedure.

The calibration model selector 480 may operate in conjunction with the sensor locator 470, employing the determined geospatial difference(s) between sensors 111 to determine an appropriate calibration model to be used for calibrating one or more of such sensors 111. The determined calibration model(s) may be implemented by the processor 410 in conjunction with the memory 420 (e.g., storing calibration models in the SW 425 to be executed by the processor 410).

The secondary parameter identifier 490 may be configured to determine whether the sensed data of an identified sensor 111 is affected by a secondary parameter (e.g., temperature). For example, the secondary parameter identifier 490 may determine a secondary parameter based at least in part on the type of data sensed and/or the technology employed for the sensor 111. Once identified, the processor 410 may adjust or correct the sensed data associated with the sensor 111 to mitigate the effect of the secondary parameter on the sensed data, for example, by implementing an adjustment procedure stored in the memory 420.

Thus, the components of the calibration device 130-a may be configured to implement aspects discussed above with respect to FIGS. 1 and 2. Moreover, the components of the calibration device 130-a may be configured to implement aspects discussed below with respect to FIG. 6, and those aspects may not be repeated here for the sake of brevity.

FIG. 4B shows a block diagram 400-b that illustrates a calibration device 130-b for use in calibrating one or more sensors 111 of a distributed sensor system 100, in accordance with various aspects of the present disclosure. The calibration device 130-b is another example of the calibration devices 130 of FIGS. 1 and 4A, and may implement various aspects described with reference to FIGS. 2 and 6. As shown, the calibration device 130-b includes a processor 410-a, a memory 420-a, at least one transceiver 440-a, at least one network port 445-a and at least one antenna 450-a. Each of these components are in communication, directly or indirectly, with one another (e.g., over a bus 405-a). Each of these components may perform the functions described above with reference to FIG. 4A.

In this example, the memory 420-a includes software that performs the functionality of a communications manager 430-a, a sensor identifier 460-a, a sensor locator 470-a and a calibration model selector 480-a. The memory 420-a optionally may include a secondary parameter identifier 490-a. For example, memory 420-a includes software that, when compiled and executed, causes the processor 410-a (or other components of the calibration device 130-b) to perform the functionality described above and further below. A subset of the functionality of the communications manager 430-a, the sensor identifier 460-a, the sensor locator 470-a, the calibration model selector 480-a can be included in memory 420-a; alternatively, all such functionality can be implemented as software executed by the processor 410-a to cause the calibration device 130-b to perform such functions. Other combinations of hardware/software can be used to perform the functions of the communications manager 430-a, the sensor identifier 460-a, the sensor locator 470-a, the calibration model selector 480-a, and/or the secondary parameter identifier 490-a.

FIG. 5 is a flow chart illustrating an example of a method 500 for managing data quality of a distributed sensor system. The method 500 may be performed by any of the central nodes 115 as described with reference to FIG. 1, 3A, or 3B. Broadly speaking, the method 500 illustrates a procedure by which a central node 115 may manage a distributed sensor system.

At block 505 the central node 115 may determine the quality of the data received from an individual sensor 111. As described herein, the quality of data from the sensor 111 may be determined based on various factors, including component quality of the sensor 111, age of the sensor 111, location of the sensor 111, data history of the sensor 111, range of data collected by the sensor 111.

At block 510 the central node 115 may determine whether the sensor 11 is in need of calibration. Such determination may be based on the determined quality of the data from the sensor 111. For example, the quality of the data may approach or fail to meet a threshold value. Additionally or alternatively, the quality of data may be compared to historical values of the quality of data from the sensor 111 (e.g., a certain decline in quality indicating a need for calibration). Further, additionally or alternatively, a calibration history of the sensor and the calibration requirements of the sensor 111 may be used to determine if the sensor is in need of calibration.

If calibration of the sensor is determine not to be needed, the method 500 may return to block 505 and determine an updated quality of the sensor data (based on additional data received from the sensor 111).

If calibration of the sensor is needed, the method 500 may continue to block 515. At block 515 the central node 115 may determine a relocation of one or more sensors of the distributed sensor system 100 to achieve a collocation of at least one sensor with the sensor 111 to be calibrated to support calibration, such as described herein (e.g., below with respect to FIG. 6). It should be understood that the sensor 111 to be calibrated and/or another sensor may be relocated to achieve the collocation. Then, at block 520, the central node 115 may send a message to a third party or parties (in control of the other sensor(s)) requesting that the determined relocation(s) of the other sensor(s) be performed.

The method 500 is a simplified example of how the central node 115 may manage the distributed sensor system 100. It should be understood that the method 500 may be performed as part of an overall management strategy for the distributed sensor system 100, which may include more involved determinations of relocations and/or other modifications to be performed.

FIG. 6 is a flow chart illustrating an example of a method 600 for distributed sensor calibration, in accordance with aspects of the present disclosure. The method 600 may be performed by any of the calibration devices 130 as described with reference to FIG. 1, 4A, or 4B. Broadly speaking, the method 600 illustrates a procedure by which a calibration device 130 performs distributed sensor calibration.

At block 605 the calibration device 130 may identify first and second sensors 111. The first and second sensors 111 may be configured to measure an environmental condition, such as a concentration or partial pressure of oxygen, carbon monoxide, carbon dioxide, sulfur dioxide, nitrogen oxides, particulates, hydrocarbons, water, and the like. Alternatively, the first and second sensors 111 may be configured to measure a broader condition such as temperature, pressure, or density. Alternatively, the first and second sensors 111 may be configured to measure another environmental constituent, such as an atmospheric particulate concentration.

The first and second sensors 111 may be configured to measure an environmental condition directly, or indirectly. For example, a sensor 111 may include a thermocouple that can be used to measure temperature relatively directly. In another example, a sensor assembly 110 may have an environmental sensor 111 that relies on multiple sensor elements to calculate an environmental condition, in which case the sensor 111 may be interpreted as measuring the environmental condition indirectly. In various examples, either or both of the first sensor 111 or the second sensor 111 may measure an environmental condition directly or indirectly. Furthermore, the manner in which the first sensor 111 and the second sensor 111 measure an environmental condition may be the same or different.

Identifying a sensor 111 may include identifying a particular first sensor 111 and second sensor 111 from a plurality of sensors 111 identified in information received at the calibration device 130. This information may include sensor serial numbers or IDs, as well as supporting information such as the type of environmental data, the type of the sensor 111, data format, data units, diagnostic information about the sensor 111, and the like. After identifying the first and second sensors, the method 600 may proceed to block 610.

At block 610 the calibration device 130 may collect sensed data of the first and second sensors 111. The sensed data from the first sensor 111 and the sensed data from the second sensor 111 may correspond to the same environmental condition. For instance, the sensed data from each sensor 111 may be a concentration of a particular atmospheric gas, such as carbon dioxide, in parts per million. In some examples, the sensed data from the first sensor 111 and the sensed data from the second sensor 111 may correspond to the same environmental condition, but may be in different formats. For instance, the calibration device 130 may collect data of the first sensor 111 that represents a gas concentration in parts per million, and data from the second sensor 111 that represents a gas concentration in percentage. In some examples the calibration device 130 may collect data of the first sensor 111 that represents a gas concentration in parts per million and collect data of the second sensor 111 that represents a partial pressure. Thus, in various examples the calibration device 130 may perform any of calculations, conversions, or approximations such that the sensed data from the first sensor 111 and the second sensor 111 can be suitably compared or correlated. After collecting sensed data from the first and second sensors 111, the method 600 may proceed to block 615.

At block 615 the calibration device 130 may optionally determine a difference in quality between the sensed data of the first and second sensors 111. As previously described, in various examples a difference in quality may be related to any of a grade or quality of components, an age of components, a level of noise in sensed data, an amount of sensed data, a periodicity or time period of sensed data, a data history, a calibration history, or a predetermined characteristic. After determining a difference in quality between the sensed data from the first and second sensors, the method 600 may proceed to block 620.

At block 620 the calibration device 130 may determine a directionality of calibration using the determined difference in sensed data quality. For example, where sensors 111 can be compared by relative quality, the calibration device may determine the directionality of calibration as using data from a sensor 111 associated with sensed data having higher quality to calibrate a sensor 111 associated with sensed data having a lower quality. In some examples, such as those relating to a periodicity of sensed data, a difference in quality may not refer to sensed data from two sensors 111 as being better or worse, but may instead refer to a particular characteristic of the sensed data. In such examples, the characteristic may be used to indicate a directionality of calibration. In other examples, sensed data of lower quality may still be used to contribute to a calibration, but its effect may be given a reduced weight or significance to a calibration model. After determining a directionality of calibration using the determined difference in sensed data quality, the method 600 may proceed to block 625.

At block 625 the calibration device 130 may identify whether a secondary parameter may be affecting the sensed data. For example, the measurement a sensor 111 configured to measure certain environmental conditions may rely on a secondary measurement, which may be provided to a sensor 111 or a sensor assembly 110 including the sensor 111 by various means. In such examples, the calibration of the associated sensor 111 may rely on measurements of the secondary parameter associated with the first and second sensors 111 being within a certain range of each other. In some examples, the calibration device 130 may include the secondary parameter in the determining a calibration model. If the calibration device 130 identifies that a secondary parameter may be affecting the sensed data, the method 600 may proceed to block 630. If the calibration device 130 does not identify a secondary parameter may be affecting the sensed data, the calibration device may proceed directly to block 635.

At block 630 the calibration device 130 may adjust sensed data from one or both of the first sensor 111 or the second sensor 111 based on a secondary parameter. For instance, the calibration device 130 may collect a secondary parameter measured by or otherwise provided by a sensor assembly 110 including the sensor 111, or from any other source, and adjust the sensed data from that sensor 111 based on the secondary parameter. In various examples the adjustment may be a conversion of the sensed data based on the secondary parameter, a filtering of the data based on the secondary parameter, or a selection of one or more portions of the sensed data based on the secondary parameter. In some examples, the secondary parameter may be used to select a particular portion of a calibration model, such as a calibration within a particular temperature band, a calibration within a particular pressure band, a calibration within a particular time band, and so on. After adjusting the sensed data to account for the secondary parameter effects, the method 600 may proceed to block 635.

At block 635 the calibration device 130 may determine a difference in geospatial location between a location of the first sensor 111 and a location of the second sensor 111. In some examples, determining the difference in location between the sensors 111 may include determining the location of each of the first sensor 111 and the second sensor 111. In some examples the calibration device 130 may determine a location of a sensor 111 by looking up a predetermined location stored in memory associated with the calibration device 130. In some examples the calibration device may receive information associated with the location of the sensor 111, which may be received from a database at a central node 115 or other processing device or received from a sensor assembly 110 that includes the sensor 111. In examples where a sensor assembly 110 transmits location information, the location information may be predetermined information stored at the sensor assembly 110, or may be otherwise measured by the sensor assembly 110. For instance, in some examples the sensor assembly 110 may be configured to determine a location or a sensor 111 by receiving signals from a GPS or GLONASS satellite constellation, or any other terrestrial or satellite-based system that provides signals that can be used for positioning. In various examples, the location of the sensor 111 as determined by a sensor assembly 110 can be transmitted to the calibration device 130 by a wired or wireless communication link 135.

In some examples, the difference in geospatial location between the first sensor 111 and the second sensor 111 may be a one-dimensional distance value. In some examples the difference in geospatial location may be a two- or three-dimensional value, such as a vector. For instance, the difference in geospatial location may reflect a two-dimensional projection of distance at a reference elevation or altitude, such as at sea level or any other elevation or altitude. A two-dimensional projection may be characterized by a difference in latitude and longitude, a difference in distance in a north-south direction and a distance in an east-west direction, a vector having a distance magnitude and a cardinal direction, or any other suitable two-dimensional representation. A three-dimensional difference in geospatial location may be characterized by a difference in latitude, longitude, and elevation, a vector having a distance magnitude and angles in two principal directions, or any other suitable three-dimensional representation. After determining a difference in geospatial location between a location of the first sensor and a location of the second sensor, the method 600 may proceed to block 640.

At block 640 the calibration device 130 may identify whether the first sensor 111 and the second sensor 111 are separated by a variable relative position. For instance, one or both of the first sensor 111 or the second sensor 111 may be moving, in which case the relative position between them may change. In some examples, the calibration device 130 may simply identify that the distance between the first sensor 111 and the second sensor 111 changes over time. In some examples, the calibration device may determine that both a distance and an orientation from the first sensor 111 to the second sensor 111 has changed. In either case, if the calibration device has identified that the first sensor 111 and the second sensor 111 are separated by a variable relative position, the method 600 may proceed from block 640 to block 655. If no change in relative position is identified, the method may proceed to block 645. At block 645, the method 600 can include determining a calibration model using the determined difference in geospatial location between the first and second sensors 111. For instance, as previously described the calibration device 130 may apply low-pass filtering to sensed data from one of both of the first and second sensors 111 based on the distance between sensors 111, and then use a correlation between the filtered data from the first and second sensors 111 to determine a calibration model. In other examples, the calibration device may modify portions of the sensed data based on a relative orientation between the first sensor 111 and the second sensor 111. For example, the calibration device 130 may have data or other understanding of a prevailing wind or some other source that may be affecting an environmental condition, and may impose a time offset or other phase lag to sensed data corresponding to an environmental measurement from one or both of the first sensor 111 or second sensor 111, and use a correlation of the adjusted data to determine a calibration model.

In some examples, determining a calibration model may include rejecting at least a portion of the data entirely from a calibration. For example, data collected from a sensor 111 may be rejected from a calibration model if the sensor 111 is too far from a target sensor 111 to be calibrated. In some examples, the calibration device 130 may reject data based on identifying or suspecting an error condition associated with the sensor 111. Such identified or suspected error conditions may include an identified drop-out, a sensor “railed” to an output limit, an output that is erroneously locked at an output value, an output that is drifting away from a plausible value, an erratic or noisy output, and the like.

Determining a calibration model may include various means of correlation between data associated with the first and second sensors 111, and adjustment of parameters associated with one or both of the first or second sensors 111. For instance, the calibration device 130 may identify that data for an environmental condition associated with the first sensor 111 is lower than data for the environmental condition associated with the second sensor 111. The calibration device 130 may have various information or criteria to suggest that the first and second sensors 111 should be more closely correlated than their transmitted data may suggest. Therefore, the calibration device 130 may determine a calibration model that includes increasing a sensor gain or sensor offset associated with the first sensor. After determining the calibration model using the determined difference, the method 600 can proceed to block 655.

At block 650, in examples where the calibration device 130 has determined a variable relative position between the first and second sensors, the method 600 can include selecting or adjusting portions of the sensed data and determining a calibration model using the determined difference in geospatial location between the first and second sensors 111.

For example, when applying a frequency-based decomposition or filtering as part of the calibration model, a low-pass filter cutoff frequency may be higher for portions of the data where the sensors 111 are more closely located, and a low-pass filter cutoff frequency may be lower for portions of the data where the sensors 111 are located farther apart. If the distance between the first sensor 111 and the second sensor 111 is greater than a threshold value, portions of the sensed data may be ignored altogether.

In examples where the relative orientation between the first and second sensor 111 changes with respect to the direction of prevailing wind, the calibration device 130 may apply a different time offset or phase lag to each sensor during various portions of the sensed data. In this way, measurements of transient phenomena can be more accurately aligned, providing a more accurate set of data for calibration.

Following the selection or adjustment of portions of the sensed data, the calibration device 130 can apply any of the techniques previously described to determine a calibration model. For instance, the calibration device 130 may determine adjustments to be applied to the calibration of the first sensor 111, such as an adjustment to a sensor gain, a sensor offset, or any other parameter used to convert a physical measurement taken by the sensor 111 to data representing the environmental condition. After selecting portions of the sensed data and determining the calibration model using the determined difference, the method 600 can proceed to block 655.

At block 655, the calibration device 130 may apply the determined calibration model for sensor calibration. As previously described, the calibration model may be applied directly at a sensor 111, at a portion of a sensor assembly 110 that contains the sensor 111, or at any other device that receives sensed data from the sensor, such as a central node 115 or other processing device or data acquisition unit. Thus, the calibration device 130 may send an instruction to adjust a computational parameter that converts a physical sensor measurement to environmental condition data, with the instruction sent to any one or more of these devices.

The calibration device 130 may additionally provide any one or more of these devices with at least a portion of the calibration model as necessary to improve the correlation of sensors 111 in the distributed sensor system 100. For instance, upon receiving at least a portion of a calibration model, a sensor 111, a sensor assembly 110, or a central node 115 or other processing device can make an adjustment to a sensor gain, sensor offset, or any other parameter that converts a physical measurement into useful data representing the measured environmental condition. In some examples, calibration information for a plurality of sensors 111 may be communicated by the calibration device 130 to a central node 115 or other processing device, and the central node 115 or other processing device can use calibration information for the plurality of sensors 111 to adjust sensed data from the plurality of sensors 111 to improve correlation in the distributed sensor system 100.

Thus, the method 600 provides for calibrating a sensor 111 in a distributed sensor system 100. It should be noted that the method 600 is just one implementation and that the operations of the method 600 can be rearranged or otherwise modified such that other implementations are possible. For example, blocks 615 and 620, blocks 625 and 630, and blocks 640 and 650 as depicted in dashed lines may be optional. For example, blocks 615 and 620 may be omitted if the calibration is performed on both the first sensor and the second sensor. Further, if both the first sensor and the second sensor are stationary (e.g., fixed in location), then blocks 640 and 650 may be omitted.

Furthermore, although the method 600 is described with reference to a first sensor 111 and a second sensor 111, it should be appreciated that a distributed sensor calibration may be performed between any number of sensors. For example, a calibration device may identify a plurality of sensors 111, collect data of the plurality of sensors 111, and determine a calibration model based on the plurality of sensors 111. The calibration device may apply weighting to the sensed data collected from individual sensors 111 based on such factors as a location of the sensors 111 or a difference in location between various individual sensors 111 and a sensor 111 to be calibrated.

In some examples when more than two sensors meet calibration criteria simultaneously (e.g., overlapping periods of time), the calibration operations may be such that sequential/serial calibration of sensors has the same net/functional effect as a single multi-sensor calibration: A→B, C→B={A, C}→B. When a sensor is both being used for calibration and being calibrated, calibration may proceed in a decreasing quality order of directionality: where quality(A)>quality(B)>quality(C), directionality of calibration is A→B→C; sequaentially, A→B, B→C (improving data quality of B before using B to calibrate C).

FIG. 7 is a flow chart of an example of a method 700 for managing data quality of a distributed sensor system 100, in accordance with various aspects of the present disclosure. The method 700 may be performed by any of the central nodes 115 as described with reference to FIG. 1, 3A, or 3B. Broadly speaking, the method 700 illustrates a procedure by which a central node 115 may manage a distributed sensor system.

At block 705 the central node 115 may receive sensed data from the sensors 111 of the distributed sensor system 100. As discussed above, this may be wirelessly via a transceiver of the central node 115 or via a network port when the sensors 111 are networked. In some examples, receiving data from the sensors 111 may include receiving the data via a central server.

At block 710 the central node 115 may compute or otherwise determine an aggregate data quality of the system 100. The aggregate data quality may be based on quality of the data received from the individual sensors 111 and the geographical locations of the individual sensors 111. As discussed above, the quality of the data may be based on quality metrics of the individual sensors 111, with or without weighting.

At block 715 the central node 115 may determine that a relocation of at least one sensor may improve the aggregate data quality of the system 100. The determined relocation may be based on various factors including, but not limited to, one or more areas of interest, sensor locations with respect to the areas of interest (e.g., sensor density at or near the areas of interest) efficiencies of movement(s) to achieve the relocation (e.g., based on the geographical locations of the individual sensors), relative quality of the sensors and/or the data received from the sensors (e.g., quality metrics), learned knowledge of the system (e.g., movements of mobile sensors, results of prior completed relocations, probabilities that requested relocations will be completed, etc.), management parameters for the system, etc.

Once a relocation(s) of a sensor(s) is determined, the method 700 may continue to block 720. At block 720, the central node 115 may generate and send one or more messages to communicate the desired relocation(s) of the individual sensor(s) involved. For example, the central node may send a message to a user of the distributed sensor system, a manager of the at least one sensor, and/or a vehicle carrying the sensor that communicates the determined relocation. The message(s) may request that the individual sensor(s) be relocated within a certain amount of time and/or for a certain amount of time (e.g., to facilitate calibration of one or more of the sensors).

The method 700 is another simplified example of how the central node 115 may manage the distributed sensor system 100. It should be understood that the method 700 may be performed as part of an overall management strategy for the distributed sensor system 100, which may include more involved determinations of relocations and/or other modifications to be performed.

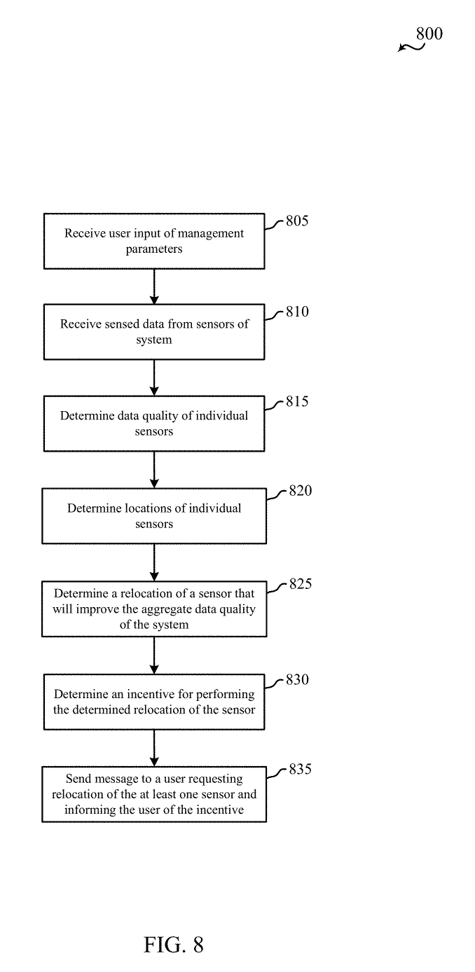

FIG. 8 is a flow chart illustrating an example of a method 800 for managing data quality of a distributed sensor system, in accordance with various aspects of the present disclosure. The method 800 may be performed by any of the central nodes 115 as described with reference to FIG. 1, 3A, or 3B. Broadly speaking, the method 800 illustrates a procedure by which a central node 115 may manage a distributed sensor system.

The method 805 may begin at block 805 with the central node 115 receiving user (e.g., administrator) input of management parameters. For example, the management parameters may set goals for the system 100, such as a desired level of aggregate data quality, a desired level of data quality for sub-areas of interest, a desired level of data quality of a particular type of sensors and/or type of sensed data, maintaining calibrations of individual sensors, obtaining sufficient data for sub-areas of interest and/or to account for contributing factors (e.g., temperature or other factors that may affect the sensed data), obtaining data that is of particular interest (e.g., relatively high pollution observations), or the like. It should be understood that management parameters may be received as part of an initial setup for managing the system 100, and may be updated or otherwise modified over time as appropriate or desired (e.g., to account for learned knowledge of the effects of managing the system 100, to address changing goals for operation of the system 100, etc.).

At block 810 the central node 115 may receive sensed data from the sensors 111 of the distributed sensor system 100. It should be understood that the sensed data may be received on an ongoing basis. For example, the central node 115 may poll each of the individual sensors 111 periodically to obtain the sensed data for a period of time. Alternatively, the individual sensors 111 may automatically send sensed data to the central node 115 (e.g., upon filling a local memory buffer, or continuously if the central node 115 is configured to receive data from the sensors in real time).

At block 815 the central node 115 may determine data quality of the individual sensors 111 (or quality of the data from the individual sensors 111). It should be understood that the central node 115 may perform such operations for each management time period (e.g., periodic management updates).

At block 820 the central node 115 may determine locations of the individual sensors 111 corresponding to when the sensed data was collected. It should be understood that the central node 115 may perform such operations on an ongoing basis (e.g., to track movements of mobile sensors and to update locations based on performed relocations). The locations of fixed sensors may not change, in general, from an initial layout of the system 100. However, fixed sensors also may be relocated, added, removed and/or updated or replaced such that the locations need to be updated.

At block 825, the central node 115 may determine a relocation of a sensor 111 to be performed to adjust the system 100. The proposed/recommended relocation may be determined based on one or more management parameters from block 805. For example, if a management parameter is to maintain or improve the aggregate data quality of the system 100, then the operations at block 825 may involve determining the aggregate data quality of the system 100 and determining one or more relocations of sensors that will improve the aggregate data quality (e.g., as discussed above with respect to blocks 710 and 715 of the method 700 shown in FIG. 7). If a management parameter is to maintain calibration of individual sensors 111 of the system 100, then the operations at block 825 may involve determining the quality of the sensed data from an individual sensor, determining whether the individual sensor is in need of calibrations and determining one or more relocations of sensors that will facilitate calibration of the individual sensor (e.g., as discussed above with respect to blocks 505, 510 and 515 of the method 500 shown in FIG. 5).

At block 830 the central node 115 may determine an incentive for performing the determined relocation of each sensor to be relocated. The incentive for relocating a particular sensor will be based on a particular incentive system being employed. Further, various factors may be taken into account by the central node 115 to determine the incentive for a particular relocation to be performed, such as described above with respect to the system manager 395 of the central node 115 shown in FIG. 3A.

Once the desired relocation and the associated incentive are determined, at block 835 the central node 115 may generate and send a message to a user (e.g., controller of the particular sensor to be relocated). The message may request the user to perform the relocation (e.g., within a certain time frame) and may inform the user of the incentive the user will receive upon completion of the requested relocation.

The method 800 is another example of how the central node 115 may manage the distributed sensor system 100. It should be understood that the method 800 may be performed as part of an overall management strategy for the distributed sensor system 100, which may include more involved determinations of relocations and/or other modifications to be performed.

Having described various technical details of the present invention, the following provides further practical details by way of examples.

At any given time, ‘t’, there may be many solutions for sensor layouts that improve (e.g., maximize) both network aggregate quality and geographical coverage at time ‘t+1’. The recommendation to move one or more sensors from their original positions, x, to new positions, x′ (the solution of the layout) will follow one of the many possible solutions.

It should be noted that there is an explicit tradeoff between coverage and quality. Higher density means closer proximity of sensors to one another, thus greater opportunity to transfer information from one sensor to another (e.g., for calibration, verification and/or augmentation, etc.). As such, if the goal is to improve (e.g., optimize) solely the aggregate quality of the system, the result would be a Null solution of relocating sensors such that all sensors of the distributed sensor system are collocated at a particular time—having all sensors of the distributed sensor system collocated at a particular time yielding an unacceptable (e.g., minimal) geographical coverage.

A solution may likely involve gridding the sensors of the distributed sensor system, where the distance between sensors (grid spacing) is variable and a function of how much adjacent sensors need to be calibrated. The ability to calibrate a sensor using collocation is in part a function of how close it is to another sensor. Thus, sensors that would benefit from or require a high delta quality should be spaced more closely. Mobile sensors, however, won't likely be statically gridded because the location of the sensors may change. As such, a solution may be continually recomputed as the locations of mobile sensors change, with the layout recommendation (relocation) for a specific mobile sensor being updated to account for its movements in an attempt to fit the mobile sensor to a grid. It should be noted that, more generally, the solution may involve arranging the sensors of the distributed sensor system in a mesh (rather than a grid), with the mesh edges being the distance between nodes.

In most instances, there may be several possible solutions that achieve the desired quality/coverage goal. Selection between possible solutions may be made based on one or more other factors (e.g., efficiency of performing relocations, probabilities of the relocations actually being, etc.). As noted above, the central node (e.g., system manager) may implement aspects of learning algorithms to achieve proper selection between multiple solutions.

For example, suppose the distributed sensor system includes a hundred (100) sensors, with twenty (20) of the sensors being fixed and eighty (80) being mobile. Assuming complete control of movement of the mobile sensors, then a solution may be selected that results in a least (e.g., minimal) distance that sensors travel to achieve the relocations directed by solution.

However, when the mobile sensors are controlled by a third party (e.g., user or device), then the solution may involve requesting the third party to adjust movements of the mobile sensors for a given time period (e.g., one week) to achieve the relocations directed by solution with efficient (e.g., least or minimal distance) movements of the mobile sensors. After the first week has ended, the central node (e.g., system manager) may have learned that only ten percent (10%) of the mobile sensors completed the requested relocations/movements. Thus, for a second week, a solution may be selected that yields the most improvement in quality from collocations (e.g., yields the most instances in which a high quality sensor is collocated with a low quality sensor to achieve large delta quality change for the lower quality sensor), rather than efficient movements. After the second week has ended, the central node (e.g., system manager) may have learned that fifty percent (50%) of the mobile sensors have regular (e.g., daily) movement patterns that do not change even when different movements/relocations are requested. Then, for a third week, a solution may be determined that does not involve requesting relocation/change in movements for those sensors, and only includes relocation requests for the other 50% of the mobile sensors.

The foregoing are examples of implementations of one or more types of learning algorithms (e.g., Bayesian learning, belief systems, etc.) that leverage past observations (e.g., observed patterns). The learning algorithm(s) may be applied to particular variables, such as distance, delta-quality, probability of requested relocations being performed. Of course, when complete control of movement of the mobile sensors is available, the probability of requested relocations being performed is not a variable (e.g., one hundred percent (100%) probability). When the distributed sensor system includes some mobile sensors that are controlled by a third party (X % probability) and other mobile sensors that are not (100% probability), a solution may involve relocations of the other mobile sensors to collocate with the mobile sensors that are controlled by a third party and have had a history of not performing requested relocations/changes in movements.

As a further example, a distributed sensor system (e.g., network) of ninety (90) sensors may be equally allocated from among three different manufacturers (thirty (30) sensors from each manufacturer). Thirty of the sensors are fixed commercial sensors and belong to a first manufacturer. Another thirty (30) are consumer sensors from a second manufacturer and belong to individuals. The final thirty (30) are vehicle-mounted sensors from a third manufacturer and belong to a taxi company. Prior knowledge of the sensors includes: a root-mean-square error (RMSE) metric in properly calibrated sensors are plus-or-minus (+/−) ten (10) parts-per-billion (ppb), +/−twenty (20) ppb, and +/−thirty (30) for the sensors from the first, second and third manufacturers, respectively; and, all of the sensors drift in such a way that the uncertainty in sensor readings increase by two (2) ppb to five (5) ppb each day a sensor is not calibrated. Time increments are measured in week intervals. It should be noted that the RMSE metric used for managing the sensor network is defined as a hybrid of prior-knowledge of sensor error (e.g., a true RMSE, such as noise) and components of predicted RMSE and uncertainty. For example, taking a worse case scenario RMSE/day for drift may include aspects of the unpredictability (uncertainty) in how the sensor actually drifts. Similarly, scaling/weighting the RMSE for areas of interest may intentionally distort the RMSE metric to achieve management preferences.

At an initial time t₀, the sensors are spaced at approximately equal distance from one another over a one hundred (100) square kilometer (sq. km) area in a metropolitan area divided into quadrants (counting counter-clockwise from the upper right), with the sensor density equal among quadrants. At time t₀, no data has been collected from any of the sensors. Also at time t₀, no relocation recommendations are given to the individuals or the taxi company, so the movements of these sensors in the metropolitan area is pseudo-random.

At time t₁, the density in quadrants I and II is observed/determined to be twenty (20) percent greater than that of quadrants III and IV. Half of the sensors in quadrants I and II have gone more than one day without sufficient collocation information to be calibrated (e.g., half the sensors have been (1) too far from a nearby sensor to calibrate, (2) too far from a nearby sensor of sufficiently high quality to calibrate, and/or (3) collocated for an insufficient period of time). At time t₁, the net RMSE metric for each sensor individually is calculated as the base error of the particular sensor (prior knowledge) and the accumulated error of the particular sensor (history, e.g., drift). The accumulated error in this example may be calculated as the worse case error (5 ppb/day) multiplied by the number of days elapsed since a prior co-location and calibration. The aggregate data quality of the distributed sensor system is calculated by taking an average of the RMSE metrics of all of the sensors of the system.

Assuming that a power-plant in quadrant I is to be prioritized for data quality, the RMSE values for all sensors in quadrant I could be increased, which would have the net effect of prioritizing the calibration (data quality) of sensors in quadrant I.

A first method for generating relocation requirements/recommendations for the sensors of the system is a relatively continuous model. At time t₁, the locations of the sensors of the system are mapped to create a heat-map/proximity-map based on the calculated RMSE metric values of the sensors. The determined solution is as follows: for sensors in an area for which the RMSE metric is greater than a certain threshold RSME metric (e.g., a critical or minimum acceptable RMSE metric, no relocation/request to relocate is made; for sensors in an area for which the RMSE metric is less than the threshold RMSE metric, relocations/requests to relocate to the nearest area in which the RMSE metric is greater than the threshold RMSE metric (collocation for calibration). Iterations over time will continue to move sensors from areas of high quality data to areas of low quality data. Above-threshold sensors may be calibrated against below-threshold sensors. The calibration model for the above-threshold sensors may be updated to have the above-threshold sensor predict the value of the below-threshold sensor, while the calibration model for the below-threshold sensor may remain unchanged. The net effect may be to decrease the RMSE metric of the above-threshold sensor to more closely match the RMSE metric of the below-threshold sensor.

A second method for generating relocation requirements/recommendations for the sensors of the system is a relatively discrete model. Assume three potential solutions: (1) relocate sensors in quadrants I and II to other nearby sensors in quadrants I and II that have a re-calibration interval (elapsed time between calibrations) of less than one day; (2) relocate sensors in quadrants I and II that have a re-calibration period of less than one day into quadrants III and IV and relocate those sensors to the nearest sensors in quadrant III or IV that have an RMSE less than +/−10 ppb; and (3) relocate sensors in quadrants I and II to other nearby sensors in quadrants I and II that have a re-calibration period of greater than one day and an RMSE less than +/−10 ppb. A predicted aggregate increase in data quality (e.g., decrease in mean RMSE) is determined for each potential solution. The solution having the greatest predicted increase in data quality is selected. The calculation and selection of one of the potential solutions is iterated at each time period.

In some cases, the recommendation of a “nearest sensor” for collocation and re-calibration can be replaced with a recommendation of a sensor that is suitable for re-calibration purposes but more likely to be visited by the user or operator of the sensor to be relocated than the “nearest sensor.” This alternative recommendation can be based on observed patterns associated with movement of the sensor in response to prior relocation and re-calibration instructions or recommendations. For example, a hit or success rate of previous relocation/re-calibration instructions sent to the sensor to be relocated can be useful in determining which relocation/re-calibration instructions the user or operator of the sensor to be relocated is most likely to comply with. For example, a first sensor may be directed to collocate with a second sensor that is further from the current location of the first sensor than an equally viable third sensor based on knowledge or an assumption that the location of the second sensor overlaps better with the travel patterns of the user or operator of the first sensor. In some cases, the selection of a target for relocation/re-calibration may be further based on a time of day or other variable affecting the travel patterns of the user or operator of the first sensor.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for managing data quality of a distributed sensor system, comprising:
receiving sensed data from a plurality of sensors of the distributed sensor system at a central node of the distributed sensor system;
determining, by the central node, an aggregate data quality of the distributed sensor system based at least in part on quality of data from and geographical locations of individual sensors of the plurality of sensors; and
sending a message to a user, the message requesting a relocation of at least one sensor from the plurality of sensors based at least in part on a determination by the central node that the relocation of the at least one sensor will improve the aggregate data quality of the distributed sensor system.

2. The method of claim 1, wherein the central node actively updates the aggregate data quality based at least in part on accumulated knowledge of the quality of data from and the geographical locations of the individual sensors.

3. The method of claim 1, further comprising:
determining, by the central node, a quality metric for each of the plurality of sensors, the quality metric associated with quality of sensed data received from each of the plurality of sensors, wherein the central node takes into account the determined quality metrics for determining the aggregate data quality of the distributed sensor system.

4. The method of claim 1, further comprising:
determining weighting factors for individual sensors of the plurality of sensors, wherein the central node takes into account the determined weighting factors for determining the aggregate data quality of the distributed sensor system and determining that the relocation of the at least one sensor will improve the aggregate data quality of the distributed sensor system.

5. The method of claim 1, wherein the central node identifies a second sensor of the plurality of sensors to be calibrated and determines that the relocation of the at least one sensor will facilitate calibration of the second sensor.

6. The method of claim 5, wherein the central node identifies the second sensor based at least in part on a calibration history of the second sensor.

7. The method of claim 5, wherein the central node identifies the second sensor based at least in part on quality of data received from the second sensor.

8. The method of claim 1, further comprising:
determining, by the central node, an incentive for performing the requested relocation of the at least one sensor.

9. The method of claim 8, wherein the incentive is determined based at least in part on a quality of the data from the at least one sensor.

10. The method of claim 8, wherein the incentive is determined based at least in part on an expected improvement in the aggregate data quality from performing the requested relocation of the at least one sensor.

11. The method of claim 1, further comprising:
determining, by the central node, the at least one sensor to relocate based at least in part on the geographical locations of the individual sensors of the distributed sensor system.

12. The method of claim 1, further comprising:
determining, by the central node, the at least one sensor to relocate based at least in part on a quality metric for each of the plurality of sensors, the quality metric associated with quality of sensed data received from each of the plurality of sensors.

13. An apparatus for calibrating an environmental sensor of a distributed environmental sensor system, comprising:
a processor and memory communicatively coupled to the processor, the memory comprising computer-readable code that, when executed by the processor, causes the apparatus to:
receive sensed data from a plurality of sensors of the distributed sensor system;
determine an aggregate data quality of the distributed sensor system based at least in part on quality of data from and geographical locations of individual sensors of the plurality of sensors; and
send a message to a user, the message requesting a relocation of at least one sensor from the plurality of sensors based at least in part on a determination by the processor that the relocation of the at least one sensor will improve the aggregate data quality of the distributed sensor system.

14. The apparatus of claim 13, wherein the computer-readable code, when executed by the processor, causes the apparatus to:
actively update the aggregate data quality based at least in part on accumulated knowledge of the quality of data from and the geographical locations of the individual sensors.

15. The apparatus of claim 13, wherein the computer-readable code, when executed by the processor, causes the apparatus to:
determine a quality metric for each of the plurality of sensors, the quality metric associated with quality of sensed data received from each of the plurality of sensors, wherein apparatus takes into account the determined quality metrics for determining the aggregate data quality of the distributed sensor system.

16. The apparatus of claim 13, wherein the computer-readable code, when executed by the processor, causes the apparatus to:
determine weighting factors for individual sensors of the plurality of sensors, wherein the apparatus takes into account the determined weighting factors for determining the aggregate data quality of the distributed sensor system and determining that the relocation of the at least one sensor will improve the aggregate data quality of the distributed sensor system.

17. The apparatus of claim 13, wherein the computer-readable code, when executed by the processor, causes the apparatus to:
identify a second sensor of the plurality of sensors to be calibrated and determine that the relocation of the at least one sensor will facilitate calibration of the second sensor.

18. The apparatus of claim 13, wherein the computer-readable code, when executed by the processor, causes the apparatus to:
determine an incentive for performing the requested relocation of the at least one sensor.

19. The apparatus of claim 13, wherein the computer-readable code, when executed by the processor, causes the apparatus to:
determine the at least one sensor to relocate based at least in part on the geographical locations of the individual sensors of the distributed sensor system.

20. The apparatus of claim 13, wherein the computer-readable code, when executed by the processor, causes the apparatus to:
determine the at least one sensor to relocate based at least in part on a quality metric for each of the plurality of sensors, the quality metric associated with quality of sensed data received from each of the plurality of sensors.
